(19) United States
(12) Patent Application Publication
(10) Pub. No.: US 2023/0413786 A1
(43) Pub. Date: Dec. 28, 2023

(54) PIG REARING SUPPORT APPARATUS, PIG REARING SUPPORT METHOD, AND NON-VOLATILE STORAGE MEDIUM STORING PIG REARING SUPPORT PROGRAM

(71) Applicants: NH Foods Ltd., Osaka (JP); National Agriculture and Food Research Organization, Tsukuba-shi (JP)

(72) Inventors: Masaki OKUDA, Ibaraki (JP); Daisuke UCHIDA, Ibaraki (JP); Shin SUKEGAWA, Ibaraki (JP); Daiichiro FUCHIMOTO, Ibaraki (JP); Mitsuhito MATSUMOTO, Ibaraki (JP)

(21) Appl. No.: 18/463,453

(22) Filed: Sep. 8, 2023

Related U.S. Application Data
(63) Continuation of application No. PCT/JP2022/008203, filed on Feb. 28, 2022.

(30) Foreign Application Priority Data
Mar. 11, 2021 (JP) 2021039703

(51) Int. Cl. A01K 29/00; G06V 40/20; G06V 20/52; G06V 10/774

(52) U.S. Cl. CPC A01K 29/005; G06V 40/20; G06V 20/52; G06V 10/774; A01K 1/02

(57) ABSTRACT

A pig rearing support apparatus includes: an acquirer configured to acquire image data of an image captured by a camera unit installed facing a pen in which sows are raised in a group; a detector configured to detect mounting behavior of the sows based on the image of the image data; and a count processor configured to count the number of times the mounting behavior is detected within a preset observation period. Such a pig rearing support apparatus can inform a breeder at the right time without involving excessive cost or labor whether there is any sow that shows estrus symptoms among sows being raised in a group in a pen.

### CROSS REFERENCE TO RELATED APPLICATION

The present application is based upon and claims the benefit of priority from Japanese Patent Application No. 2021-039703, filed on Mar. 11, 2021, and International application No. PCT/JP2022/008203 filed on Feb. 28, 2022, the entire contents of which are hereby incorporated by reference.

### BACKGROUND

### Technical Field

The present disclosure relates to a pig rearing support apparatus, a pig rearing support method, and a non-volatile storage medium storing a pig rearing support program.

### Background Art

To recognize estrus symptoms of livestock, an apparatus that detects mounting behavior of the livestock is known (see, for example, Patent Literature 1).

### CITATION LIST

### Patent Literature

Patent Literature 1 Japanese Patent Laid-Open No. 2016-220588

### SUMMARY

### Technical Problem

In pig farming, from the viewpoint of increasing the annual litter size, maintaining the breeding cycle at appropriate intervals, and the like, it is important to determine the estrus of sows. Available sow raising methods include stall raising and group raising. In recent years, from the viewpoint of animal welfare, there has been a trend towards the use of a technique for group raising carried out in an enclosed place of a certain size generally called a pen. In group raising, mounting behavior can be monitored by attaching a sensor to each sow, but the attached sensors might fall due to contact among housed sows, resulting in injuries or accidental ingestion. Besides, it is not practical that a breeder should keep on monitoring the mounting behavior of a large number of sows.

The present disclosure has been made to solve the above problem and provides a pig rearing support apparatus and the like that can inform a breeder at the right time without involving excessive cost or labor whether there is any sow that shows estrus symptoms among sows being raised in a group in a pen.

### Solution to Problem

A pig rearing support apparatus according to a first aspect of the present disclosure includes: an acquirer adapted to acquire image data of an image captured by a camera unit installed facing a pen in which sows are raised in a group; a detector adapted to detect mounting behavior of the sows based on the image of the image data; and a count processor adapted to count the number of times the mounting behavior is detected within a preset observation period.

A pig rearing support method according to a second aspect of the present disclosure includes: an acquisition step of acquiring image data of an image captured by a camera unit installed facing a pen in which sows are raised in a group; a detection step of detecting mounting behavior of the sows based on the image of the image data; and a counting step of counting the number of times the mounting behavior is detected within a preset observation period.

A pig rearing support program according to a third aspect of the present disclosure makes a computer execute: an acquisition step of acquiring image data of an image captured by a camera unit installed facing a pen in which sows are raised in a group; a detection step of detecting mounting behavior of the sows based on the image of the image data; and a counting step of counting the number of times the mounting behavior is detected within a preset observation period.

### Advantageous Effect of Disclosure

The present disclosure provides a pig rearing support apparatus and the like that can inform a breeder at the right time without involving excessive cost or labor whether there is any sow that shows estrus symptoms among sows being raised in a group in a pen.

### BRIEF DESCRIPTION OF DRAWINGS

FIG. 1 is a diagram showing an overall picture of a pig farming environment that adopts a pig rearing support apparatus according to an aspect of the present disclosure.

FIGS. 2A and 2B are diagrams illustrating mounting behavior.

FIG. 3 is a diagram illustrating procedures of a mounting behavior detection process that uses a learning model.

FIG. 4 is a diagram showing a hardware configuration of the pig rearing support apparatus and peripherals.

FIG. 5 is a diagram illustrating a standard observation period.

FIG. 6 is a diagram illustrating a count list.

FIG. 7 is a diagram showing a display example on a breeder terminal that has received an excess notice.

FIG. 8 is a flow diagram illustrating process procedures of an arithmetic processor.

FIG. 9 is a diagram showing an overall picture of a pig farming environment that has adopted a pig rearing support apparatus according to another aspect of the present disclosure.

FIG. 10 is a diagram illustrating a count list of a pig rearing support apparatus according to still another aspect of the present disclosure.

### DESCRIPTION OF EMBODIMENTS

The present disclosure will be described below with reference to an aspect of the disclosure, but the disclosure set forth in the claims is not limited to the aspect described below. Besides, all the components described in the aspect are not necessarily essential for the solution to the problem.

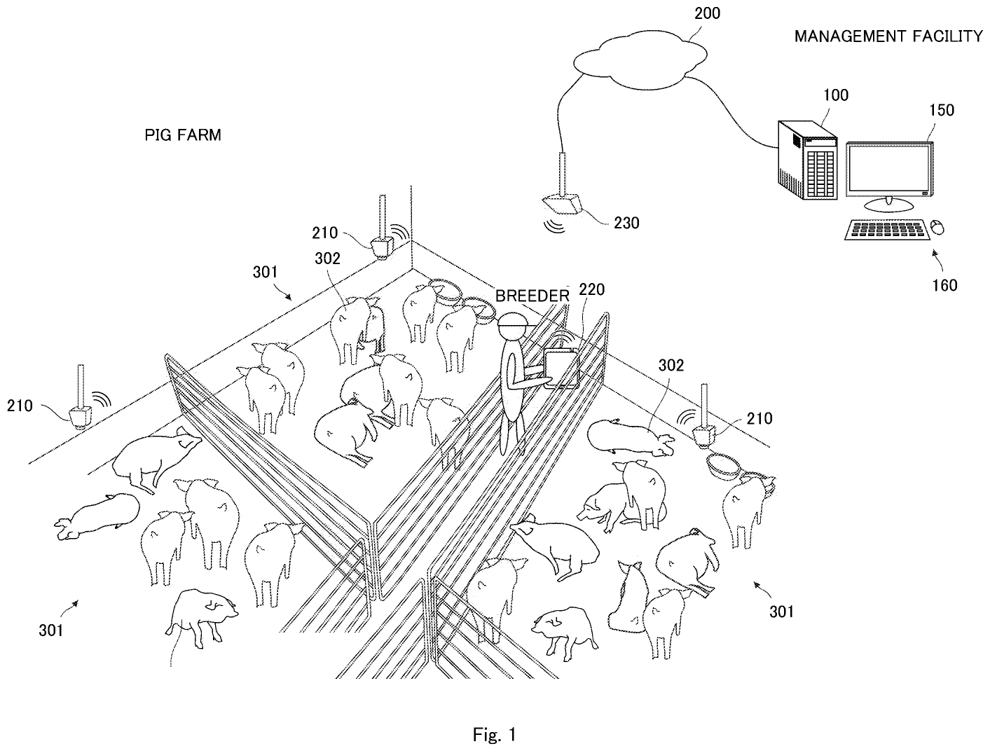

FIG. 1 is a diagram showing an overall picture of a pig farming environment that adopts a pig rearing support apparatus according to the present aspect. A pig farm includes multiple pens 301 partitioned by walls and fences. Multiple (e.g., around 10) sows 302 are housed in each pen 301 and raised in a group. Note that the number of sows raised in each pen 301 can be adjusted according to the breed, rearing environment, and the like of the sows 302.

A camera unit 210 for use in observing the housed sows 302 is installed in each pen 301. To capture bird's-eye images of the entire pen 301 under observation, the camera unit 210 is installed facing the pen 301, for example, by being hung from the ceiling. The camera unit 210 converts the captured images into image data and transmits the image data to a server 100 via a network 200. Specifically, a wireless unit 230 installed in a facility is connected to the network 200, and the camera unit 210 can transmit the image data to the server 100 by establishing wireless communication with the wireless unit 230. Note that as the network 200 interconnecting the camera unit 210 and the server 100, the Internet or an intranet may be used, but when a management facility in which the server 100 is installed is provided in the pig farm, short-range wireless communication may be adopted.

A breeder who takes care of the sows 302 can carry a breeder terminal 220. The breeder terminal 220 is, for example, a tablet terminal or a smart phone capable of exchanging various information with the server 100 via the wireless unit 230 and the network 200. The breeder can, for example, input a rearing log to the breeder terminal 220 and transfer the rearing log to the server 100 or call the rearing log stored on the server 100. Besides, if an excess notice described later is received, the breeder terminal 220 displays the notice.

The server 100 as a pig rearing support apparatus is installed in the management facility. The server 100 is connected to the network 200. The server 100 acquires image data in sequence from the camera units 210 installed in the respective pens 301, detects mounting behavior of the sows 302 based on the image data, and counts the number of times mounting behavior is detected. The server 100 can display the results of detection on a display monitor 150 in response to a request from a manager or breeder. The display monitor 150 is a monitor equipped, for example, with a liquid-crystal panel. The server 100 is connected with an input device 160 adapted to accept input from the manager or breeder. The input device 160 is made up of a keyboard, a mouse, a touch panel superimposed on a display surface of the display monitor 150, and the like.

Now, in pig farming, from the viewpoint of increasing the annual litter size, maintaining the breeding cycle at appropriate intervals, and the like, it is important to determine the estrus of sows 302. However, in pens in which sows are raised in groups in this way, in order for the breeder to observe a large number of sows steadily and determine the estrus of sows, lots of skill and labor are required of the breeder. The pig rearing support apparatus according to the present aspect detects mounting behavior of the sows 302 in the pens 301, informs the breeder that at least any of the sows 302 in the pens 301 exhibit estrus symptoms, and thereby supports rearing work.

When there are multiple pens 301 in the pig farm as shown in FIG. 1, even by simply being informed, by the pig rearing support apparatus, about which pens 301 contain the sows 302 showing estrus symptoms, the breeder can be relieved of much labor. That is, the breeder does not have to perform extraction work with respect to the sows 302 showing estrus symptoms until being informed by the pig rearing support apparatus, and even when being informed, the breeder can perform extraction work only with respect to the specified pens 301. If it is indicated that a limited number of sows 302 in a single pen 301 show estrus symptoms, even an inexperienced breeder can extract the sows 302 relatively easily.

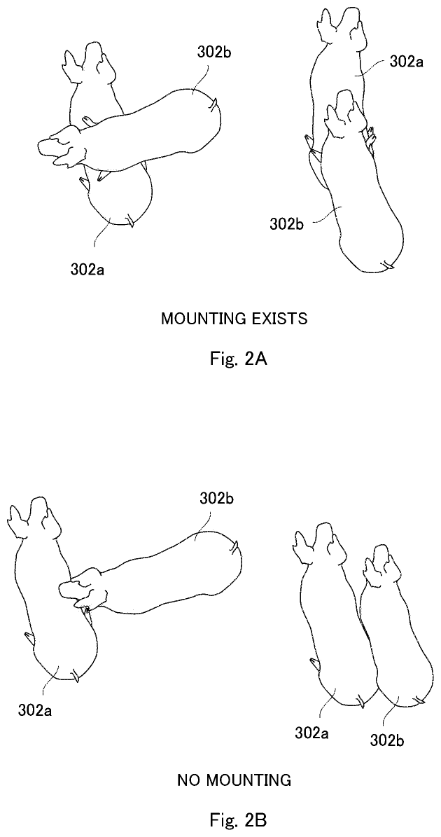

The pig rearing support apparatus according to the present aspect detects mounting behavior of sows 302 using images captured by the camera unit 210. The mounting behavior is known as a behavior of the sows 302 showing estrus symptoms. FIGS. 2A and 2B are diagrams illustrating mounting behavior by looking down sows 302 in a pen from above. FIG. 2A shows two examples in which a sow 302b is mounting on the back of another sow 302a. The mounting behavior of a sow 302b mounting on another sow is known as a behavior indicative of an estrus symptom.

It is known that estrus symptoms of cows can also be estimated from mounting behavior, but because cows are raised in small numbers or because the price of cows per head is high, a technique of attaching an infrared sensor, an acceleration sensor, or another sensor on each cow is adopted to detect mounting behavior. However, in group raising in which a relatively large number of pigs are housed in a pen of limited space, it is not practical to attach a sensor to each sow.

In view of such a foregoing background, the pig rearing support apparatus according to the present aspect detects mounting behavior of sows 302 raised in a group based on images captured by the camera unit 210 installed facing the pen 301. From a bird's-eye image of the pen 301, a mounting condition can be detected based on how the sows 302 lie one on top of another. For example, a contour of each sow is extracted, and if regions surrounded by contours overlap each other, it is determined that a mounting condition exists. In so doing, the proportion or site of an overlap region, the shapes of the contours of the respective sows 302, and the like may be taken into consideration. For example, if the proportion of an overlap region is 30% or above the size of the upper sow, it is determined that a mounting condition exists. If the head and the trunk overlap each other, it is determined that a mounting condition exists, but if the head and the head overlap each other, it is not determined that a mounting condition exists. If contour shapes indicate that the upper sow is lying down, it is not determined that a mounting condition exists. In this way, by analyzing an overlap region between pigs appearing on an image, the presence or absence of mounting behavior can be detected.

FIG. 2B shows two examples in which a sow 302a and a sow 302b are located side by side, but are not recognized as being in mounting condition. It is often observed that the head of a sow 302b partially overlap the trunk of a sow 302a or a sow 302a and a sow 302b cuddle up to each other facing in a same direction as illustrated in FIG. 2B, but these conditions are not determined as being mounting conditions.

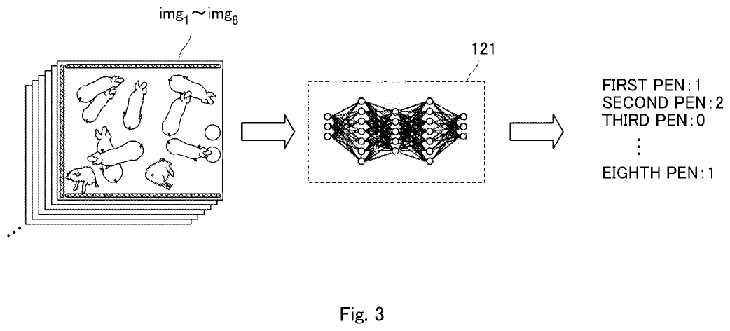

In this way, with a technique for detecting mounting behavior based on a bird's-eye image of sows 302 raised in a group, there is no fear of false detection whereby, for example, two sows carrying sensors adapted to detect mounting would be detected to be in mounting condition when located next to each other. Unlike domestic animals such as cows raised in a group in a large open pasture, the bird's-eye camera unit 210 can be installed relatively easily for the sows 302 raised in a group in an indoor pen, and thus an image-based detection technique is suitable.

Whereas a mounting condition can be determined analytically by extracting contours from an acquired image as described above, according to the present aspect, mounting behavior is detected by inputting an acquired image to a learning model learned from a teacher image containing a region in which pigs overlap each other. FIG. 3 is a diagram illustrating procedures of a mounting behavior detection process that uses a neural network 121 for detection, which is a learning model. The neural network 121 for detection is created in advance by supervised learning conducted by giving large volumes of teacher data linked to bird's-eye images of pens in which sows are raised in groups, using the number of detections as correct answer, where the number of detections is the number of sows to be determined as being in mounting condition in the images. To determine the number of detections in the teacher data, for example, an operator extracts regions in which pigs overlap from a bird's-eye image, determines whether the pigs are in mounting condition, and counts the number of sows determined as being in mounting condition in the bird's-eye image. The operator and the like determine whether the pigs are in mounting condition based on the proportion or site of a region in which pigs overlap as well as on contour shapes and orientations of the extracted sows.

The neural network 121 for detection, which is a learning model generated in this way, is used by being incorporated into the server 100, which is the pig rearing support apparatus. Specifically, for example, if the pig farm has eight pens 201 under observation, image data is sent to the server 100 in sequence from the eight camera units 210 taking bird's-eye views of the respective pens 201. Images img₁ to img₈ of the image data are inputted in sequence to the neural network 121 for detection. Each time an image is inputted, among the numbers of sows determined as being in mounting condition in the image, the neural network 121 for detection outputs the most probable number as the number of detections. In this way, the number of detections in each pen 201 is obtained, for example, as follows: the number of detections in the image img₁ of the first pen is “1,” the number of detections in the image img₂ of the second pen is “2,” the number of detections in the image img₃ of the third pen is “0,” . . . and the number of detections in the image img₈ of the eighth pen is “1.” The server 100 repeats such a process for a predetermined observation period and counts and adds up the numbers of detections for each pen 201.

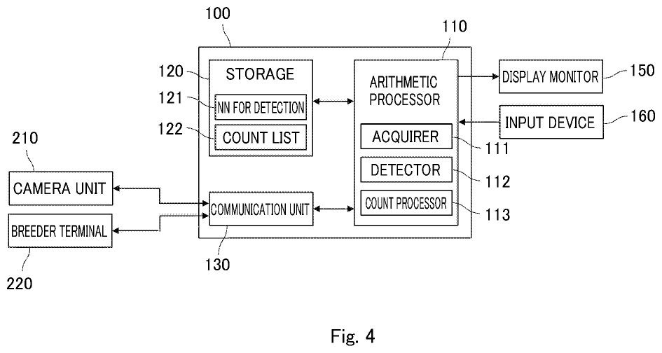

FIG. 4 is a diagram showing a hardware configuration of the server 100 and peripherals, where the server 100 acts as the pig rearing support apparatus. As described above, the server 100 can be connected with the display monitor 150, the input device 160, the camera unit 210, and the breeder terminal 220.

The server 100 mainly includes an arithmetic processor 110, a storage 120, and a communication unit 130. The arithmetic processor 110 is a processor (CPU: central processing unit) adapted to control the server 100 and execute programs. The processor may be linked with a processing chip such as ASICs (application specific integrated circuits) and a GPU (graphics processing unit). The arithmetic processor 110 reads the pig rearing support program out of the storage 120 and performs various processes relevant to pig rearing support.

The storage 120 is a non-volatile storage medium and is made up, for example, of a HDD (hard disk drive). In addition to programs configured to control the server 100 and perform server processes, the storage 120 can store various parameter values, functions, display element data, lookup tables, and the like used for control and arithmetic operations. In particular, the storage 120 stores the neural network 121 for detection and a count list 122. As described above, upon accepting an input of an image captured by the camera unit 210, the neural network 121 for detection outputs in the image, the number of detections, which represents the number of pigs in mounting condition. The count list 122 is a record on counting of mounting behavior, but will be discussed specifically later. Note that the storage 120 may be made up of multiple pieces of hardware. For example, a storage medium storing programs and a storage medium storing the neural network 121 for detection may be provided on separate pieces of hardware.

The communication unit 130, which includes, for example, a LAN unit, transmits an imaging control signal generated by the arithmetic processor 110 to the camera unit 210 via the network 200 or delivers image data sent from the camera unit 210 to the arithmetic processor 110. The communication unit 130 also relays data exchanges carried out between the breeder terminal 220 and the arithmetic processor 110. Note that the communication unit 130 may relay exchanges of data or control signals with other external devices. For example, the communication unit 130 can also be used to capture update data on the pig rearing support program or the neural network 121 for detection from an external server.

The arithmetic processor 110 also serves the role of a functional arithmetic processor adapted to run various arithmetic operations according to processes specified by the pig rearing support program. The arithmetic processor 110 can function as an acquirer 111, detector 112, and a count processor 113. The acquirer 111 mainly acquires image data of an image captured by the camera unit 210 and delivers the image data to the detector 112. The detector 112 mainly detects mounting behavior of sows 302 based on the image of the image data received from the acquirer 111 and delivers results to the count processor 113. The count processor 113 mainly counts the number of times mounting behavior is detected by the detector 112 within a preset observation period.

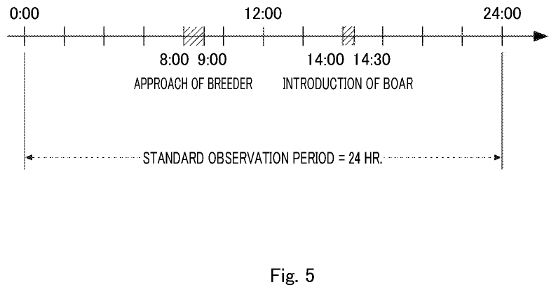

Next, processes of the count processor 113 will be described. FIG. 5 is a diagram illustrating a standard observation period as a period during which the count processor 113 counts the number of times of mounting behavior. The count processor 113 resets the counted number of times every predetermined standard observation period.

According to the present aspect, the standard observation period is set to 24 hours. The count processor 113 counts the number of times mounting behavior is detected in each pen 201 during the standard observation period. Specifically, as described using FIG. 3, in each of the images img₁ to img₈ of the image data acquired periodically from each pen 201 by the acquirer 111, the detector 112 detects the number of sows that perform mounting behavior (the number of detections), using a neural network 121 for detection. For example, if the number of detections in the image img₂ of the second pen is “2,” at the time of detection, two sows 302 are getting on top of other two sows 302, respectively, and it is said that mounting behavior has been observed twice. This procedure is repeated for the standard observation period to count how many times mounting behavior is detected in each pen 201.

However, even periods included in the standard observation period are excluded from counting, if the periods correspond to some situations. Here, as periods of such exclusion, a breeder approach period and a boar introduction period have been set. The breeder approach period has been set as a fixed period including an expected period from the time when the breeder approaches the pen 301 to the time when the breeder leaves the pen 301. The boar introduction period has been set as a fixed period including an expected period from the time when a boar is introduced into the pen 301 to the time when the boar is taken out of the pen 301.

As a breeder approach period, for example, the period from 8:00 a.m. to 9 a.m. when the breeder enters the pen 301 for feeding has been set. Besides, a period when the breeder approaches the pen 301 to clean the pen 301, inspect the sows 302, or the like may be set as a breeder approach period. The boar introduction period is a period when the boar is temporarily introduced into the pen 301 to facilitate estrus of the sows 302, and the period from 14:00 to 14:30 has been set. In this way, when the breeder or a boar approaches or enters the pen 301, the sows 302 get into a certain excited state, and even sows 302 that do not show estrus symptoms may perform irregular behavior including mounting behavior. Therefore, regarding an event that may cause irregular behavior, a fixed period including the period of the event can be set as an exclusion period to be excluded from counting. Specifically, the exclusion period can be set by adding periods before and after the event, i.e., a period in which the sows 302 start getting excited by sensing the event and a period in which the sows 302 regain calmness after the event, to the period of the event.

Note that the exclusion period can be set in advance by the manager or the like by operating the input device 160. There is no need that the exclusion period be included in every standard observation period and, for example, if a boar is introduced on a specified date, the exclusion period may be set only for the standard observation period on the specified date. The count processor 113 excludes the exclusion period set in this way from counting. Specifically, the count processor 113 can adopt the process of: stopping counting done by the count processor 113, making the detector 112 stop detection of mounting behavior, making the acquirer 111 stop acquiring image data, making the camera unit 210 stop imaging, or the like.

The period at which the detector 112 detects mounting behavior using image data is adjusted and set such that a single sequence of mounting behavior will be detected as one sequence, by considering agile movements of the sows 302 and duration of mounting behavior. Besides, the period can be set by taking into consideration the breed, rearing environment, age in months, and the like of the sows 302. Alternatively, a single sequence of mounting behavior may be detected as one sequence by acquiring images successively at a rate of a few frames per second for a fixed period and analyzing continuous behavior of the sows 302 under observation.

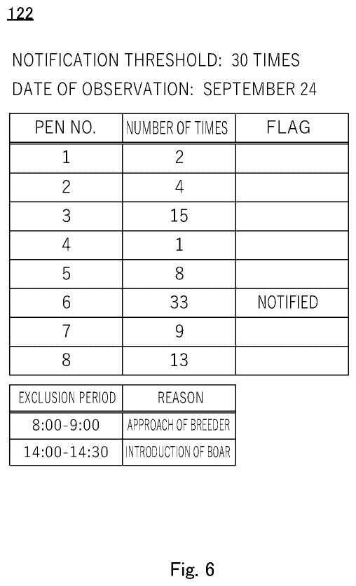

The count processor 113 manages the numbers of times of mounting counted in the respective pens 301, using a count list 122. FIG. 6 is a diagram illustrating an example of the count list 122. One count list 122 is generated in one standard observation period and updated as appropriate during the observation period.

The count list 122 includes a notification threshold and a date of observation. The notification threshold is a value set in advance by the manager or the like. When the number of times of mounting counted in each pen 301 exceeds the notification threshold, the count processor 113 outputs an excess notice, notifying the breeder terminal 220 and the like to that effect. The manager or the like sets the notification threshold by taking into consideration the breed and rearing environment of the sows 302 and especially the number of sows 302 housed in one pen 301 and the like. More specifically, a threshold that makes it possible to determine that a sow 302 showing estrus symptoms is present in a given pen 301 is set based on past statistics or experience. In the example of FIG. 6, “30 times” is set. The date of observation is the date on which the observation is being conducted. If the count list 122 is referred to after the observation, the date of observation is the date on which the observation was conducted. If the standard observation period is less than 24 hours, for example, the time at which the observation was started may be added.

The count list 122 includes a summary sheet that indicates the numbers of times of mounting behavior counted in the respective pens 301. The summary sheet includes Pen No. (e.g., 1st to 8th pens for a total of eight pens), Number of Times counted, and Flag information. If it is confirmed that there is a pen 301 in which the number of times counted has exceeded the notification threshold, the count processor 113 generates and outputs an excess notice to the breeder terminal 220 and the like. In so doing, the count processor 113 outputs pen information about the pen 301, of which the number of times counted has exceeded the notification threshold, by attaching the pen information to the excess notice. According to the present aspect, the pen number is attached as the pen information. Regarding the pen 301, of which the excess notice has been outputted, information as to “Notified” is recorded as flag information.

The count list 122 includes information about the exclusion period. Specifically, the exclusion period described using FIG. 5 is recorded as list information. Note that the longer the exclusion period, shorter the counting period accordingly, and consequently even if there are sows that show estrus symptoms, there can be a case in which the number of times of counting does not exceed the notification threshold. Thus, by taking into consideration the proportion of the total hours of a preset exclusion period in the standard observation period, the count processor 113 may modify the notification threshold automatically. For example, if the standard observation period is 24 hours and the exclusion period is 3 hours in total, the notification threshold is modified to 30×(24−3)/24=26.25 times. In this case, if it is confirmed that there is a pen 301 whose counted number of times of mounting exceeds the modified notification threshold, the count processor 113 outputs an excess notice.

If the number of sows 302 housed varies from pen 301 to pen 301, the notification threshold may be modified on a pen by pen basis by considering the numbers of sows housed. For example, if a notification threshold of “30 times” has been set by assuming that 10 sows 302 will be housed in each pen, regarding a pen 301 housing eight sows 302, the notification threshold is modified to 30×(8/10)=24 times. In this case, the count processor 113 outputs an excess notice when the number of times of mounting exceeds 24 times, which has been counted based on the pen 301 housing eight sows.

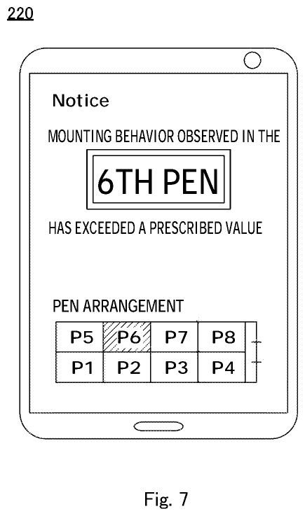

FIG. 7 is a diagram showing a display example on the breeder terminal 220 that has received an excess notice. As described above, when the count processor 113 outputs an excess notice, the breeder terminal 220 receives the excess notice and displays the content of the excess notice on a display panel. Specifically, as illustrated in FIG. 7, by referring to the pen information attached to the excess notice, the breeder terminal 220 displays the pen number (“6th pen” in the illustrated example) of the pen, of which the number of times of mounting behavior has exceeded the notification threshold (prescribed value). If there is an indoor map showing a pen arrangement of the pig farm, the indoor map is displayed as well such that the location of an appropriate pen will be recognized. Note that in addition to providing such a display, the breeder terminal 220 may produce a notification sound.

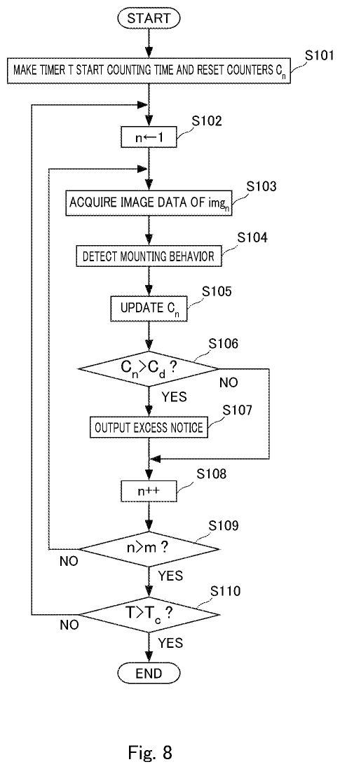

Next, process procedures of a pig rearing support method that uses the server 100 will be described. FIG. 8 is a flow diagram illustrating process procedures of the arithmetic processor 110. The flow starts at a start time of the standard observation period. Note that a process during the exclusion period is omitted in the description here.

In step S101 at the start of observation, as an initial process, the count processor 113 makes an elapsed timer T start counting time and resets all counters C_{N} adapted to count the number of times of mounting of eight sows 302 housed in the nth pen. Note that here, the number of pens in the pig farm is m, and counters C₁ to Cₘ are provided for the respective pens.

The count processor 113 goes to step S102, sets the variable n to 1, and switches the counter to be processed to C₁ accordingly. The processing goes to step S103, in which the acquirer 111 acquires the image data of the image imgₙ from the camera unit 210 directed at the nth pen via the communication unit 130. When n=1, the image data of the image img₁ is acquired from the camera unit 210 directed at the 1st pen. The acquirer 111 delivers the acquired image data to the detector 112.

In step S104, the detector 112 inputs the image imgₙ of the received image data to the neural network 121 for detection read out of the storage 120 so as to output the number of sows 302 (the number of detections) that perform mounting behavior in the image imgₙ. The detector 112 delivers the number of detections to the count processor 113. In step S105, the count processor 113 adds the number of detections received from the detector 112 to the value of the counter Cₙ at that time and thereby updates Cₙ.

The count processor 113 goes to step S106 and determines whether the updated value of Cₙ has exceeded the notification threshold Ca. If it is determined that the notification threshold Ca has been exceeded, the count processor 113 goes to step S107 and generates and outputs an excess notice to the breeder terminal 220. In so doing, information is added as pen information, indicating that the pen that has exceeded the notification threshold is the nth pen. Once the excess notice is outputted, the count processor 113 goes to step S108. If it is determined in step S106 that the notification threshold Ca has not been exceeded, the count processor 113 goes to step S108 by skipping step S107.

The count processor 113 increments the variable n in step S108, and goes to step S109. In step S109, the count processor 113 determines whether the variable n has exceeded the number m of pens in the pig farm. If it is determined that the number m of pens has not been exceeded, the count processor 113 returns to step S103 and performs the process of step S103 with respect to the incremented variable n. If it is determined that the number m of pens has been exceeded, the count processor 113 goes to step S110.

In step S110, the count processor 113 determines whether the elapsed timer T has exceeded a standard observation period T_{c}. If it is determined that the standard observation period T_{c} has not been exceeded, the count processor 113 returns to step S102 after an interval corresponding to a predetermined period. If it is determined that standard observation period T_{c} has been exceeded, the series of processes are finished. If observations are to be carried out continuously, processes are started again from step S101.

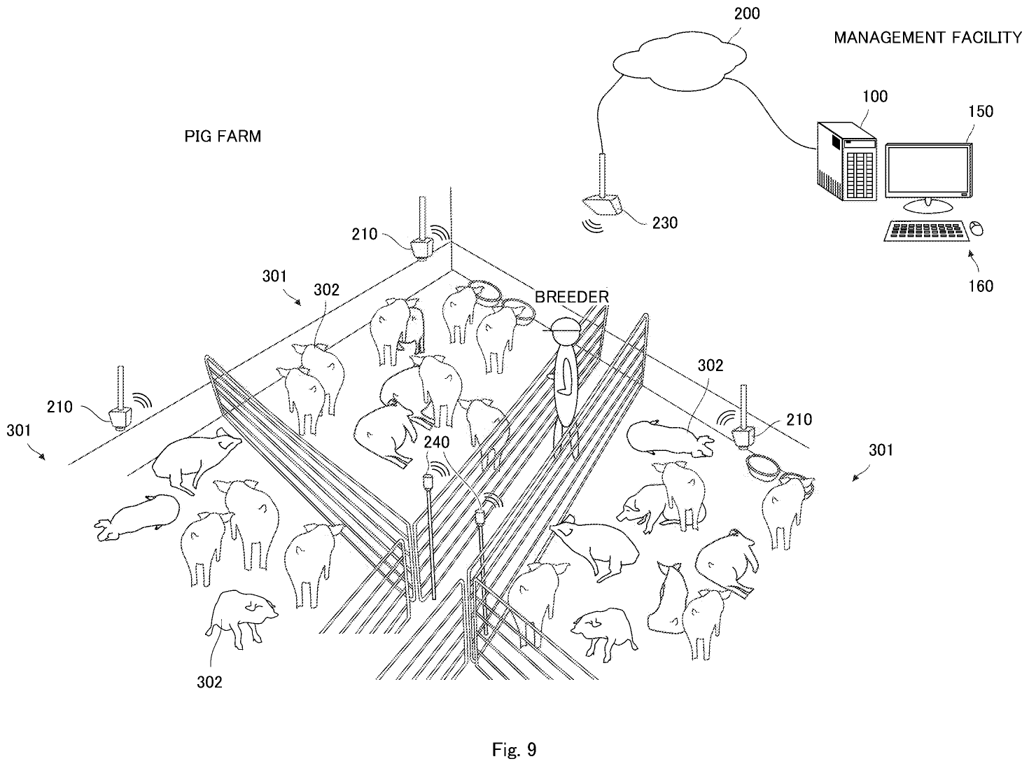

Next, some other examples of the present aspect will be described. FIG. 9 is a diagram showing an overall picture of a pig farming environment that has adopted a pig rearing support apparatus according to another aspect. Components similar to those in FIG. 1 are denoted by the same reference numerals as the corresponding components in FIG. 1, and description thereof will be omitted.

In the example shown in FIG. 9, the breeder does not carry the breeder terminal 220, and a notification lamp 240 is installed adjacent to each pen 301 instead. The notification lamps 240 are connected to the server 100 via the wireless unit 230 and the network 200. When the number of times of mounting behavior counted, for example, in the 5th pen exceeds the notification threshold, the server 100 transmits a notification signal corresponding to the excess notice to the notification lamp 240 installed adjacent to the 5th pen and thereby lights up the notification lamp 240. With such notification lamps 240, the breeder can recognize the pen 301 to which the breeder should go, even if the breeder does not carry the breeder terminal 220. The breeder can search for any sow showing estrus symptoms among the sows 302 housed in the pen 301 indicated by the notification lamp 240.

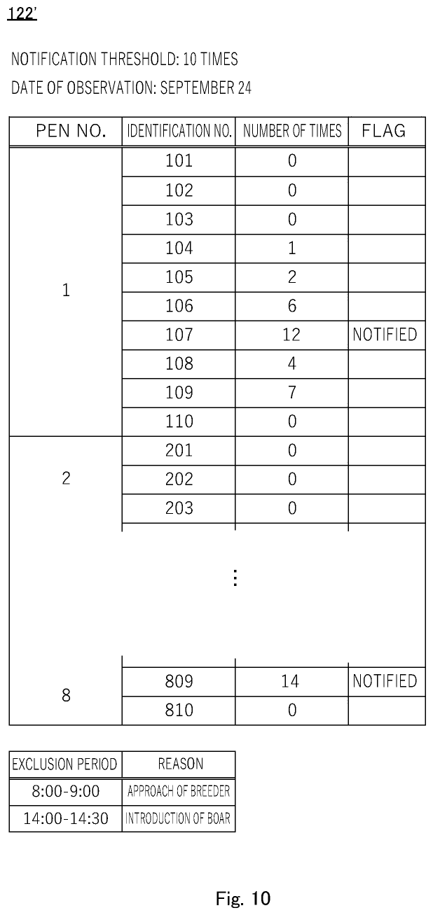

FIG. 10 is a diagram illustrating a count list 122′ of a pig rearing support apparatus according to still aspect example. In the example described above, the multiple sows 302 housed in the same pen 301 are not recognized by being distinguished from one another. Therefore, when any of the sows 302 housed in a specific pen 301 under observation performs mounting behavior, one time of mounting behavior is detected. For example, if the notification threshold is set to 30 times, both when a single sow 302 performs mounting behavior more than 30 times and when each of ten sows 302 performs mounting behavior three or four times, the count processor 113 outputs an excess notice. That is, even if it is clear in which pen 301 mounting behavior in excess of a prescribed value was detected, the breeder needs to discern whether a specific sow 302 shows intense estrus symptoms, there are multiple sows 302 that have started to show estrus symptoms, or there is a combination thereof.

On the other hand, a technique for individually distinguishing and recognizing the multiple sows 302 housed in each pen 301 has come to be known. For example, by attaching an identification marker to each of the sows 302 and analyzing images obtained by imaging the marked sows with the camera unit 210, it is possible to carry out individual identification. Alternatively, by capturing images of respective sows 302 when the sows 302 are housed in the pen 301 and associating the captured images with identification numbers, it may be detected using a learning model whether the sow 302 whose mounting behavior is detected subsequently matches the captured image associated with any of the identification numbers.

The count list 122′ shown in FIG. 10 is used when the sows 302 housed in each pen 301 can be identified individually. Each pen 301 houses, for example, ten sows 302 that are distinguished from one another by identification numbers assigned to the respective sows 302. The detector 112 detects mounting behavior and pinpoints the identification number of the sow 302 performing the mounting behavior. The count processor 113 receives the information from the detector 112 and updates the number of times of mounting of the sow 302 corresponding to the pinpointed identification number.

Note that when individual identification is carried out, preferably the notification threshold is set to a smaller value than when individual identification is not carried out. In the count list 122′, the notification threshold is set to 10 times. When a specific sow 302 exceeds the notification threshold, the count processor 113 outputs an excess notice to the breeder terminal 220 by attaching information about the identification number. If the notification lamp 240 described with reference to FIG. 9 includes a display, the count processor 113 may output an excess notice to the notification lamp 240 adjacent to the pen that houses the specific sow 302 and display the identification number of the sow 302 on the display of the notification lamp 240. If information about the specific sow 302 is also available, the breeder can easily find out the specific sow 302 from the multiple sows 302 housed in the pen 301.

Whereas in the present aspect described above using some examples, one camera unit 210 is installed in each pen 301, a camera unit adapted to take a bird's-eye view of multiple pens 301 collectively may be installed. In that case, the acquirer 111 can divide the image acquired from the camera unit along boundaries between the pens 301 and deliver the resulting images in sequence to the detector 112.

Whereas in the present aspect described above, the numbers of times of mounting are counted in multiple pens 301 on a pen by pen basis, the pig rearing support apparatus may count the number of times of mounting in a single pen 301. By simply being informed that there is a sow that shows estrus symptoms among the sows 302 being raised in a group in a pen 301, the breeder will have his/her work effort reduced.

In the present aspect described above, an output destination of the excess notice is either the breeder terminal 220 or the notification lamp 240, but is not limited thereto. The count processor 113 may display information about the excess notice directly on the display monitor 150 connected to the server 100. When the number of times of mounting being counted exceeds the notification threshold, the count processor 113 may constantly output the number of times of mounting being counted, in addition to or instead of outputting the excess notice. For example, the current numbers of times of mounting counted in the respective pens 301 may be listed on the breeder terminal 220.

In the present aspect described above, the server 100 functions as the pig rearing support apparatus, but the hardware configuration is not limited to this. If the portable terminal described as the breeder terminal 220 performs processes similar to the processes of the server 100, the portable terminal can function as the pig rearing support apparatus. If, for example, part of the processes of the server 100 is undertaken by the breeder terminal 220, a systems implemented by coordination between the server 100 and the breeder terminal 220 can serve as the pig rearing support apparatus.

What is claimed is:

1. A pig rearing support apparatus comprising:
an acquirer configured to acquire image data of an image captured by a camera unit installed facing a pen in which sows are raised in a group;
a detector configured to detect mounting behavior of the sows based on the image of the image data; and
a count processor configured to count a number of times the mounting behavior is detected within a preset observation period.

2. The pig rearing support apparatus according to claim 1, wherein the count processor outputs an excess notice when the number of times exceeds a preset threshold.

3. The pig rearing support apparatus according to claim 2, wherein the count processor counts the number of times of the mounting behavior in each pen of a plurality of pens, and when outputting the excess notice, the count processor attaches to the excess notice, pen information about a first pen of the plurality of pens that is under observation and that exceeds the threshold.

4. The pig rearing support apparatus according to claim 2, wherein the count processor counts the number of times of the mounting behavior by identifying each of the sows raised in a group, and when outputting the excess notice, the count processor attaches to the excess notice, identification information about a first sow that shows the mounting behavior.

5. The pig rearing support apparatus according to claim 1, wherein the detector detects the mounting behavior using a learning model learned from a teacher image containing a region in which pigs overlap each other.

6. The pig rearing support apparatus according to claim 1, wherein the count processor excludes a fixed period from counting, the fixed period including a period from when a breeder approaches the pen to when the breeder leaves the pen.

7. The pig rearing support apparatus according to claim 1, wherein the count processor excludes a fixed period from counting, the fixed period including a period from when a boar is introduced into the pen to when the boar is taken out of the pen.

8. A pig rearing support method comprising:
an acquisition step of acquiring image data of an image captured by a camera unit installed facing a pen in which sows are raised in a group;
a detection step of detecting mounting behavior of the sows based on the image of the image data; and
a counting step of counting the number of times the mounting behavior is detected within a preset observation period.

9. A non-volatile storage medium storing a pig rearing support program that makes a computer execute:
an acquisition step of acquiring image data of an image captured by a camera unit installed facing a pen in which sows are raised in a group;
a detection step of detecting mounting behavior of the sows based on the image of the image data; and
a counting step of counting the number of times the mounting behavior is detected within a preset observation period.
